(19) United States
(12) Patent Application Publication
(10) Pub. No.: US 2016/0370129 A1
(43) Pub. Date: Dec. 22, 2016

(54) ADHESIVE APPLICATOR COVER

(71) Applicant: Graco Minnesota Inc., Minneapolis, MN (US)

(72) Inventors: Matthew Ryan Theisen, Woodbury, MN (US); Parker J. Haffley, Hudson, WI (US); Mark T. Weinberger, Mounds View, MN (US)

(21) Appl. No.: 15/177,883

(22) Filed: Jun. 9, 2016

Related U.S. Application Data
(60) Provisional application No. 62/181,934, filed on Jun. 19, 2015.

(51) Int. Cl. F28F 9/00; B05C 5/00; F28F 1/00; B05C 11/10

(52) U.S. Cl. CPC F28F 9/001; B05C 11/1002; B05C 5/001; F28F 1/00

(57) ABSTRACT

A cover assembly for a liquid adhesive applicator protects a user from burns in case the applicator is touched and provides additional insulation for the applicator, thereby saving energy. The cover includes a first side panel and a second side panel connected to each other by posts extending through and around the applicator. A front panel is secured between the first side panel and the second side panel. A first insulating sheet may be disposed between the first side panel and a first side of the applicator to provide further insulation. Similarly, a second insulating sheet may be disposed between the second side panel and a second side of the applicator.

### CROSS-REFERENCE TO RELATED APPLICATION

This application claims the benefit of U.S. Provisional Application No. 62/181,934 filed on Jun. 19, 2015, and entitled for “ADHESIVE APPLICATOR COVER,” the disclosure of which is incorporated by reference in its entirety.

### BACKGROUND

The present disclosure relates generally to systems for dispensing liquid adhesive. More particularly, the present disclosure relates to covers for a dispensing module.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

The dispensing modules for hot melt dispensing systems are heated to prevent the liquid adhesive from solidifying within the dispensing module. As a result, the dispensing modules generate significant heat. Covers for the dispensing module are typically solid and thereby transmit heat from the dispensing module. As such, a user may be burned by touching the heated dispensing module or the cover.

### SUMMARY

According to an embodiment of the present disclosure, a liquid adhesive dispensing module includes a manifold having a first side, a second side, a front end, and a back end, a dispensing module connected to the manifold and configured to receive liquid adhesive from the manifold, a first side panel spaced from the first side, and a second side panel spaced from the second side. The first side panel includes a first plurality of cooling vents. The second side panel includes a second plurality of cooling vents.

According to another embodiment of the present disclosure, a liquid adhesive dispensing system includes a container for storing adhesive pellets, a melter capable of heating the adhesive pellets into a liquid adhesive, a feed system for transporting the adhesive pellets from the container to the melter, a supply system for transporting the liquid adhesive from the melter, and a dispensing system for receiving the liquid adhesive from the supply system and administering the liquid adhesive. The dispensing system includes a manifold having a first side, a second side, a front end, and a back end, an adhesive inlet attached to the manifold and configured to receive liquid adhesive from the supply system and to provide the liquid adhesive to the manifold, a dispensing module connected to the manifold and configured to receive liquid adhesive from the manifold, an actuating assembly mounted to the manifold and configured to control the dispensing module between an open position and a closed position, and a dispensing system cover. The dispensing system cover includes a first side panel including a first plurality of cooling vents and spaced from the first side, a second side panel including a second plurality of cooling vents and spaced from the second side, and a front panel spaced from the front end of the manifold.

According to yet another embodiment of the present disclosure, a liquid adhesive dispenser cover for a liquid adhesive dispensing manifold having a first side and a second side includes a first side panel including a first plurality of cooling vents configured to be spaced from the first side of the liquid adhesive dispensing manifold, a first insulating sheet configured to be disposed between the first side and the first side panel, a second side panel including a second plurality of cooling vents configured to be spaced from the second side of the liquid adhesive dispensing manifold, a second insulating sheet disposed between the second side and the second side panel, a plurality of posts extending between and securing the first side panel to the second side panel, wherein at least one of the plurality of posts extends through the first insulating sheet, the liquid adhesive dispensing manifold, and the second insulating sheet, and a front panel spaced from a dispensing module configured to be attached to a front end of the liquid adhesive dispensing module, wherein the front panel is secured between the first side panel and the second side panel.

### BRIEF DESCRIPTION OF THE DRAWINGS

FIG. 1 is a schematic view of a system for dispensing liquid adhesive.

FIG. 2A is an exploded view of a dispensing module.

FIG. 2B is a partially exploded view of the dispensing module of FIG. 2A.

FIG. 2C is an isometric assembled view of the dispensing module of FIG. 2A.

### DETAILED DESCRIPTION

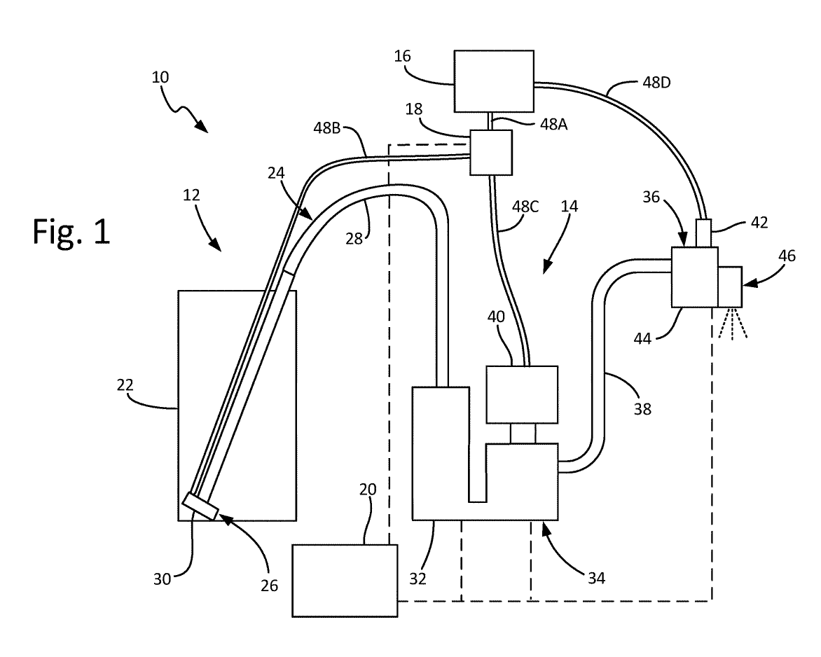

FIG. 1 is a schematic view of system 10 for dispensing liquid adhesive, such as hot melt adhesive for example. System 10 includes cold section 12, hot section 14, air source 16, air control valve 18, and controller 20. In the embodiment shown in FIG. 1, cold section 12 includes container 22 and feed assembly 24. Feed assembly 24 includes vacuum assembly 26, feed hose 28, and inlet 30. Hot section 14 includes melt system 32, pump 34, dispensing system 36, and supply hose 38. Pump 34 includes motor 40. Dispensing system 36 includes actuating assembly 42, manifold 44, and dispensing module 46.

Air source 16 is a source of compressed air supplied to components of system 10 in both cold section 12 and hot section 14. Air control valve 18 is connected to air source 16 via air hose 48a, and air control valve 18 selectively controls air flow from air source 16 through air hose 48b to vacuum assembly 26 and through air hose 48c to motor 40 of pump 34. Air hose 48d connects air source 16 to actuating assembly 42 of dispensing system 36, bypassing air control valve 18. Actuating assembly 42 controls the flow of compressed air to dispensing module 46 to actuate dispensing module 46 between an open position, thereby dispensing liquid adhesive, and a closed position, thereby preventing liquid adhesive from being dispensed. Controller 20 is in communication with various components of system 10, such as air control valve 18, melt system 32, pump 34, and/or dispensing system 36 and various components thereof, for controlling the operation of system 10.

Components of cold section 12 can be operated at room temperature, without being heated. Container 22 can be a hopper for containing a quantity of solid adhesive pellets. Suitable adhesives can include, for example, a thermoplastic polymer glue such as ethylene vinyl acetate (EVA) or metallocene. Feed assembly 24 connects container 22 to hot section 14 for delivering the solid adhesive pellets from container 22 to hot section 14. Feed assembly 24 includes vacuum assembly 26 and feed hose 28. Vacuum assembly 26 is positioned in container 22. Compressed air from air source 16 is delivered to vacuum assembly 26 to create a vacuum, inducing a flow of solid adhesive pellets into inlet 30 of vacuum assembly 26 and then through feed hose 28 to hot section 14. Feed hose 28 is a tube or other passage sized with a diameter substantially larger than that of the solid adhesive pellets to allow the solid adhesive pellets to flow freely through feed hose 28. Feed hose 28 connects vacuum assembly 26 to hot section 14.

Solid adhesive pellets are delivered from feed hose 28 to melt system 32. Melt system 32 can include a tank and resistive heating elements for melting the solid adhesive pellets to form a liquid hot melt adhesive. Melt system 32 can be sized to have a relatively small adhesive volume, for example about 0.5 liters, and configured to melt solid adhesive pellets in a relatively short period of time. Pump 34 is driven by motor 40 to pump hot melt adhesive from melt system 32, through supply hose 38, and to dispensing system 36. Motor 40 can be an air motor driven by pulses of compressed air from air source 16 and air control valve 18. Pump 34 can be a linear displacement pump driven by motor 40.

Hot melt adhesive from pump 34 is received in manifold 44 and dispensed via dispensing module 46. Dispensing system 36 can selectively discharge hot melt adhesive through dispensing module 46, whereby the hot melt adhesive is applied from dispensing module 46 and onto an object, such as a package, a case, or another object benefiting from hot melt adhesive dispensed by system 10. Dispensing module 46 is actuated between an open mode, whereby the hot melt adhesive can flow out of dispensing module 46, and a closed mode, whereby the hot melt adhesive is prevented from flowing out of dispensing module 46, by actuating assembly 42. Actuating assembly 42 may be any suitable assembly for directing compressed air to dispensing module 46, such as a solenoid valve, for example. Dispensing module 46 can be one of multiple modules that are part of dispensing system 36. Some or all of the components in hot section 14, including melt system 32, pump 34, supply hose 40, manifold 44, and dispensing module 46, can be heated to keep the hot melt adhesive in a liquid state during the dispensing process.

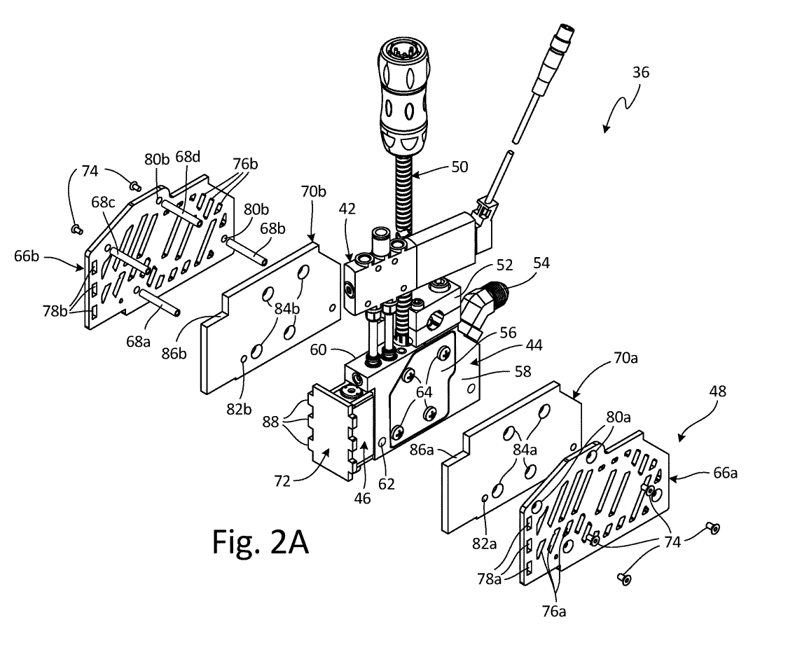

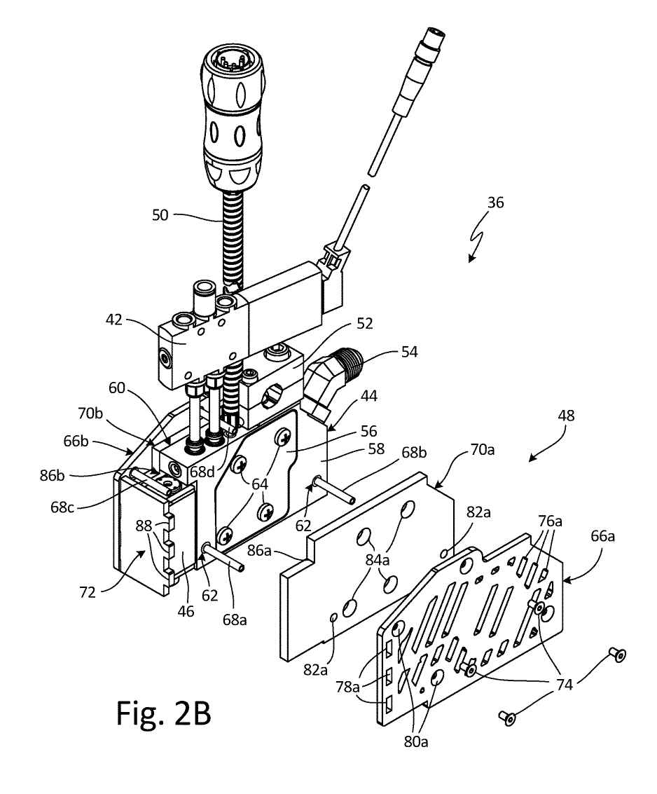

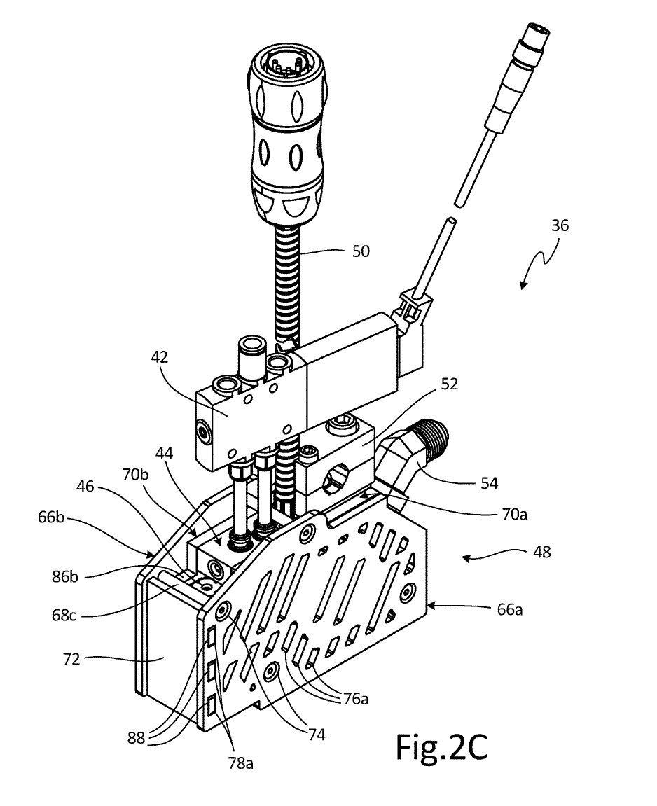

FIG. 2A is an exploded view of cover assembly 48 and dispensing system 36. FIG. 2B is a partially exploded view of cover assembly 48 and dispensing system 36. FIG. 2C is an isometric assembled view of cover assembly 48 and dispensing system 36. FIGS. 2A-2C are substantially similar and will be discussed together. Dispensing system 36 includes actuating assembly 42, manifold 44, dispensing module 46, cordset 50, mounting clamp 52, and fluid inlet 54. Manifold 44 includes manifold plate 56, first side 58, second side 60, bore 62, and plate fasteners 64. Cover assembly 48 includes side panel 66a, side panel 66b, post 68a, post 68b, post 68c, post 68d, insulating sheet 70a, insulating sheet 70b, front panel 72, and cover fasteners 74. Side panel 66a includes cooling vents 76a, retaining slots 78a, and fastener openings 80a. Side panel 66b includes cooling vents 76b, retaining slots 78b, and fastener openings 80b. Insulating sheet 70a includes post holes 82a, recesses 84a, and cutout 86a. Insulating sheet 70b includes post holes 82b, recesses 84b, and cutout 86b. Front panel 72 includes tabs 88.

Manifold plate 56 is attached to first side 58 of manifold 44 by plate fasteners 64. Manifold plate 56 secures various internal elements of manifold 44 within manifold 44. Bore 62 extends through manifold 44 between first side 58 and second side 60. Fluid inlet 54 is disposed at a back end of manifold 44 and is configured to receive a liquid adhesive from supply hose 38 (shown in FIG. 1) and to provide the liquid adhesive into manifold 44. Dispensing module 46 is attached to a front end of manifold 44 and is configured to receive liquid adhesive from manifold 44. Actuating assembly 42 is attached to manifold 44 and configured to provide compressed air to dispensing module 46 through manifold 44 to actuate dispensing module 46 between an open position and a closed position. Cordset 50 extends into manifold 44 and provides power to internal components (not shown), such as heating elements, disposed within manifold 44. Mounting clamp 52 is secured to a top of manifold 44 and is configured to receive a mounting device, such as a mounting bar, to secure dispensing system 36 at a desired location.

Side panel 66a is spaced from first side 58 of manifold 44. Cooling vents 76a extend through side panel 66a. Retaining slots 78a extend through side panel 66a proximate a front end of side panel 66a. Fastener openings 80a extend through side panel 66a and are configured to receive cover fasteners 74. Similar to side panel 66a, side panel 66b is spaced from second side 60 manifold 44. Cooling vents 76b extend through side panel 66b, and retaining slots 78b extend through side panel 66b proximate a front end of side panel 66b. Fastener openings 80b extend through side panel 66b and are configured to receive cover fasteners 74. Front panel 72 is spaced from dispensing module 46. While front panel 72 is spaced from dispensing module 46, it is understood that front panel 72 may be spaced from a front end of manifold 44 when dispensing module 46 is attached to manifold 44 at a location other than the front of manifold 44, such as a bottom of manifold 44.

Tabs 88 extend laterally from front panel 72. Retaining slots 78a and retaining slots 78b are configured to receive tabs 88 to secure front panel 72 to side panel 66a and side panel 66b. Posts 68a-68d extend between side panel 66a and side panel 66b. While front panel 72 is secured to side panel 66a and side panel 66b with tabs 88, front panel 72 may be secured relative to dispensing system 36 in any suitable manner. For example, front panel 72 may be directly attached to dispensing module 46 or manifold 44 or front panel 72 may be secured between side panel 66a and side panel 66b with snaps, hooks and loops, fasteners, or in any other suitable manner.

Posts 68a-68d are aligned with fastener openings 80a and fastener openings 80b and are configured to receive plate fasteners 64. In this way, cover fasteners 74 secure posts 68a-68d to side panel 66a and side panel 66b, and thus secure side panel 66a to side panel 66b. The ends of posts 68a-68d are preferably threaded such that the ends of posts 68a-68d may receive threaded cover fasteners 74. While posts 68a-68d are described as being connected to side panel 66a and side panel 66b with threaded fasteners, posts 68a-68b may be secured to side panel 66a and side panel 66b in any suitable manner. For example, posts 68a-68d may be snap fit to, integral with, or magnetically secured to side panel 66a and side panel 66b, or may be secured to side panel 66a or side panel 66b in any other suitable manner.

Insulating sheet 70a is disposed between side panel 66a and first side 58 of manifold 44. Recesses 84a extend through insulating sheet 70a. Post holes 82a similarly extend through insulating sheet 70a. Recesses 84a are configured to receive the heads of plate fasteners 64 to allow insulating sheet 70a to lie flush against first side 58. Insulating sheet 70b is disposed between side panel 66b and second side 60 of manifold 44. Similar to insulating sheet 70a, insulating sheet 70b includes recesses 84b and post holes 82b extending through insulating sheet 70b. Insulating sheet 70a and insulating sheet 70b are preferably identical, and as such, insulating sheet 70b may be disposed between either side panel 66a and first side 58 or side panel 66b and second side 60. Recesses 84b are thus similar to recesses 84a, and are also configured to receive plate fasteners 64 to allow insulating sheet 70b to lie flush against manifold 44, when insulating sheet 70b is disposed adjacent a side of manifold 44 that includes plate fasteners 64.

Dispensing system 36 receives liquid adhesive from hot section 14 (shown in FIG. 1) and dispenses the liquid adhesive at a desired location. Supply hose 38 (shown in FIG. 1) is attached to fluid inlet 54, and fluid inlet 54 supplies the liquid adhesive to manifold 44. The liquid adhesive flows through manifold 44 and to dispensing module 46. Actuating assembly 42 actuates dispensing module 46 between an open position, where the liquid adhesive flows out of dispensing module 46, and a closed position, where the liquid adhesive is prevented from flowing out of dispensing module 46. The internal operation of dispensing system 36 is discussed in further detail in commonly-owned International Patent Application No. PCT/US15/57403, the disclosure of which is hereby incorporated by reference in its entirety.

In FIG. 2A, posts 68a-68d are connected to and extend from side panel 66b. Cover fasteners 74 extend through fastener openings 80b in side panel 66b and engage posts 68a-68d. As such, posts 68a-68d may be hollow or have hollow ends, and the hollow ends may include internal threading to receive external threading on cover fasteners 74. Front panel 72 is disposed at a front of, and may be spaced from, dispensing module 46. Spacing front panel 72 from dispensing module 46 allows air to flow between front panel 72 and dispensing module 46 to provide cooling air to dispensing module 46. Alternatively, dispensing system 36 may include a front insulating sheet disposed between front panel 72 and dispensing module 46 or between front panel 72 and the front end of manifold 44.

In FIG. 2B, side panel 66b and insulating sheet 70b are installed on manifold 44. Posts 68a-68d extend from side panel 66b and through or around manifold 44 and project adjacent first side 58. Post 68a and post 68b extend through post holes 82b (shown in FIG. 2A) in insulating sheet 70b. Post 68a and post 68b further extend through bores 62 in manifold 44 and project out first side 58 of manifold 44. Post 68c extends from side panel 66b, over cutout 86b, and is disposed over dispensing module 46. Post 68c is configured to further extend over cutout 86a in insulating sheet 70a. Post 68d extends from side panel 66b, over the top of manifold 44, and is disposed between actuating assembly 42 and cordset 50. Front panel 72 is connected to side panel 66b by tabs 88 extending through retaining slots 78b (shown in FIG. 2A) in side panel 66b.

Insulating sheet 70a is configured to rest flush against first side 58 of manifold 44. Similarly, insulating sheet 70b is configured to rest flush against second side 60. Recesses 84a are aligned with plate fasteners 64 such that recesses 84a receive the heads of plate fasteners 64. With the heads of plate fasteners 64 disposed within recesses 84a, insulating sheet 70a abuts first side 58 of manifold 44. When insulating sheet 70a is in the installed position first post 68a and second post 68b extend through post holes 82a in insulating sheet 70a. While insulating sheets 70a/70b include two post holes 82, it is understood that insulating sheets 70a/70b may include any number of post holes 82 necessary for allowing posts 68 to extend between side panel 66a and side panel 66b. For example, insulating sheets 70a/70b may not include cutouts 86a/86b and instead may include additional post holes to allow third post 68c to extend from side panel 66a and side panel 66b.

In FIG. 2C, cover assembly 48 is installed on dispensing system 36. Side panel 66a is spaced from first side 58, and insulating sheet 70a is disposed between side panel 66a and first side 58. Side panel 66b is spaced from second side 60, and insulating sheet 70b is disposed between side panel 66b and second side 60. Front panel 72 is disposed at a front of dispensing system 36 and is secured between side panel 66a and side panel 66b. Posts 68 extend between side panel 66a and side panel 66b to secure side panel 66a and side panel 66b together. Posts 68 also extend through insulating sheets 70a/70b and manifold 44 or about manifold 44. With side panel 66a secured to side panel 66b, front panel 72 is retained between and secured to side panel 66a and side panel 66b.

Cooling vent 76a extend through side panel 66a and are configured to allow air to pass through side panel 66a. In this way, side panel 66a allows heat to escape from about manifold 44, thereby reducing the amount of heat transmitted to side panel 66a. Similarly, cooling vents 76b extend through side panel 66b and are configured to allow air, and thus heat, to pass through side panel 66b without transmitting the heat through side panel 66b. Side panel 66a is described as including cooling vents 76a and side panel 66b is described as including cooling vents 76b, but it is understood that side panels 66a and 66b may include any suitable cooling feature for allowing heat to dissipate away from manifold 44. As such, side panels 66a and 66b may be constructed of a porous material in addition to or instead of including cooling vents 76a and 76b, may be spaced from manifold 44 without insulating sheets 70a and 70b, or may include any other suitable cooling feature. Without insulating sheets 70a and 70b, side panels 66a and 66b are spaced from manifold to allow air to flow between manifold 44 and side panels 66a and 66b, thereby allowing heat to flow away from manifold 44 instead of into side panels 66a and 66b.

Insulating sheet 70a and insulating sheet 70b insulate manifold 44 to prevent heat from flowing away from manifold 44. In this way, insulating sheet 70a and insulating sheet 70b save energy as manifold 44 requires less energy input to the heating elements disposed within manifold 44, and insulating sheet 70a and insulating sheet 70b protect the user from being burned by dispensing system 36. Insulating sheet 70a and insulating sheet 70b may be made of any suitable material for insulating manifold 44 and preventing heat from being transferred directly to side panels 66a and 66b, such as a closed-cell silicone sponge.

Cover assembly 48 provides significant advantages. Side panel 66a and side panel 66b allow excess heat to vent away from manifold 44 to reduce the temperature of side panel 66a and side panel 66b. As such, side panel 66a and side panel 66b protect a user from being burned by overheated covers. Insulating sheet 70a and insulating sheet 70b further protect from burns by insulating manifold 44 to prevent side panel 66a and side panel 66b from absorbing heat from manifold 44. Insulating sheet 70a and insulating sheet 70b also increase the efficiency of manifold 44 by insulating manifold 44 thereby reducing the energy requirements of the internal heating components within manifold 44.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A vented cover liquid adhesive dispensing module comprising:
a manifold having a first side, a second side, a front end, and a back end;
a dispensing module connected to the manifold and configured to receive liquid adhesive from the manifold;
a first side panel spaced from the first side, wherein the first side panel includes a first plurality of cooling vents; and
a second side panel spaced from the second side, wherein the second side panel includes a second plurality of cooling vents.

2. The vented cover liquid adhesive dispensing module of claim 1, and further comprising:
a first insulating sheet disposed between the first side panel and the first side; and
a second insulating sheet disposed between the second side panel and the second side.

3. The vented cover liquid adhesive dispensing module of claim 2, and further comprising:
a plurality of posts extending between the first side panel and the second side panel, wherein at least one of the plurality of posts extends through the first insulating sheet, the second insulating sheet, and the manifold.

4. The vented cover liquid adhesive dispensing module of claim 3, wherein the plurality of posts extend between a first plurality of fastener openings extending through the first side panel and a second plurality of fastener openings extending through the second side panel.

5. The vented cover liquid adhesive dispensing module of claim 3, wherein the plurality of posts further comprises a first post, a second post, a third post, and a fourth post, wherein the first post and the second post extend through the manifold.

6. The vented cover liquid adhesive dispensing module of claim 5, wherein the first post and the second post pass through the first insulating sheet and the second insulating sheet.

7. The vented cover liquid adhesive dispensing module of claim 2, wherein the first insulating sheet comprises a closed-cell silicone sponge, and wherein the second insulating sheet comprises a closed-cell silicone sponge.

8. The vented cover liquid adhesive dispensing module of claim 2, and wherein:
the manifold further includes a cover plate secured to the first side; and
the first insulating sheet further includes a recess configured to receive a head of a fastener securing the cover plate to the first side, such that the first insulating sheet lies flush against the first side with the head disposed in the recess.

9. The vented cover liquid adhesive dispensing module of claim 1, and further comprising:
a front panel spaced from the front end of the manifold.

10. A vented cover liquid adhesive dispensing system comprising:
a container for storing adhesive pellets;
a melter capable of heating the adhesive pellets into a liquid adhesive;
a feed system for transporting the adhesive pellets from the container to the melter;
a supply system for transporting the liquid adhesive from the melter; and
a dispensing system for receiving the liquid adhesive from the supply system and administering the liquid adhesive, the dispensing system comprising:
a manifold having a first side, a second side, a front end, and a back end;
an adhesive inlet attached to the manifold and configured to receive liquid adhesive from the supply system and to provide the liquid adhesive to the manifold;
a dispensing module connected to the manifold and configured to receive liquid adhesive from the manifold;
an actuating assembly mounted to the manifold and configured to control the dispensing module between an open position and a closed position; and
a dispensing system cover comprising:
a first side panel spaced from the first side, wherein the first side panel includes a first cooling feature;
a second side panel spaced from the second side, wherein the second side panel includes a second cooling feature; and
a front panel spaced from the front end of the manifold.

11. The vented cover liquid adhesive dispensing system of claim 10, and further comprising:
a first insulating sheet disposed between the first side panel and the first side of the manifold; and
a second insulating sheet disposed between the second side panel and the second side of the manifold.

12. The vented cover liquid adhesive dispensing system of claim 11, and further comprising:
a plurality of posts extending between the first side panel and the second side panel, wherein the plurality of posts extend between a first plurality of fastener openings extending through the first side panel and a second plurality of fastener openings extending through the second side panel.

13. The vented cover liquid adhesive dispensing system of claim 12, wherein at least one of the plurality of posts extends through the module between the first side and the second side.

14. The vented cover liquid adhesive dispensing system of claim 12, wherein at least one of the plurality of posts extends through the first insulating sheet and the second insulating sheet.

15. The vented cover liquid adhesive dispensing system of claim 11, wherein the first insulating sheet comprises a closed-cell silicone sponge, and wherein the second insulating sheet comprises a closed-cell silicone sponge.

16. The vented cover liquid adhesive dispensing system of claim 11, and wherein:
the manifold further includes a cover secured to the first side; and
the first insulating sheet further includes a recess configured to receive a head of a fastener securing the cover to the first side, such that the first insulating sheet lies flush against the first side with the head disposed in the recess.

17. The vented cover liquid adhesive dispensing system of claim 10, wherein the first cooling feature comprises a first plurality of cooling vents extending through the first side panel, and wherein the second cooling feature comprises a second plurality of cooling vents extending through the second side panel.

18. The vented cover liquid adhesive dispensing system of claim 10, and wherein:
the front panel further comprises a first plurality of tabs extending laterally from the front panel and a second plurality of tabs extending laterally from the front panel opposite the first plurality of tabs;
the first side panel further comprises a first plurality of slots configured to receive the first plurality of tabs; and
the second side panel further comprises a second plurality of slots configured to receive the second plurality of tabs.

19. A vented cover liquid adhesive dispenser cover for a liquid adhesive dispensing manifold having a first side and a second side, the liquid adhesive dispenser cover comprising:
a first side panel configured to be spaced from the first side of the liquid adhesive dispensing manifold, wherein the first side panel comprises a first plurality of cooling vents;
a first insulating sheet configured to be disposed between the first side and the first side panel;
a second side panel configured to be spaced from the second side of the liquid adhesive dispensing manifold, wherein the second side panel comprises a second plurality of cooling vents;
a second insulating sheet disposed between the second side and the second side panel;
a plurality of posts extending between and securing the first side panel to the second side panel, wherein at least one of the plurality of posts extends through the first insulating sheet, the liquid adhesive dispensing manifold, and the second insulating sheet; and
a front panel spaced from a dispensing module configured to be attached to a front end of the liquid adhesive dispensing module, wherein the front panel is secured between the first side panel and the second side panel.

20. The vented cover liquid adhesive dispenser cover of claim 19, and wherein:
the front panel further comprises a first plurality of tabs extending laterally from the front panel and a second plurality of tabs extending laterally from the front panel opposite the first plurality of tabs;
the first side panel further comprises a first plurality of slots configured to receive the first plurality of tabs; and
the second side panel further comprises a second plurality of slots configured to receive the second plurality of tabs.
